(19) United States
(12) Patent Application Publication
(10) Pub. No.: US 2025/0041999 A1
(43) Pub. Date: Feb. 6, 2025

(54) PLIERS FOR LEVELLING SPACERS

(71) Applicant: Dakota Group S.a.s. di Zeno Cipriani & C., Affi (VR) (IT)

(72) Inventor: Zeno CIPRIANI, Affi (VR) (IT)

(21) Appl. No.: 18/696,242

(22) PCT Filed: Sep. 27, 2022
(86) PCT No.: PCT/IB2022/059167

§ 371 Date: Mar. 27, 2024

(30) Foreign Application Priority Data
Sep. 27, 2021 (IT) 102021000024671

(51) Int. Cl. B25B 7/22; B25B 23/16; E04F 21/18

(52) U.S. Cl. CPC B25B 7/22; B25B 23/16; E04F 21/1877

(57) ABSTRACT

Pliers (10) for levelling spacers comprising a wedge and a disposable element, suitable for pushing a side face of the wedge so that it enters an opening of the disposable element so that the lower face of the wedge makes two adjacent tiles between which the disposable element is arranged, coplanar, said pliers (10) comprising: —a handgrip (12) capable of being grasped by an operator; —an elongated element (14) to which is fixed a stop element (16) capable of coupling with the disposable element; —a handle (20) movably attached to the handgrip (12) and suitable for pushing the wedge; wherein the handgrip (12) comprises at least one support body (32, 42) adapted to rest on at least one of the two tiles while the operator pushes the wedge by means of the handle.

The present invention relates generally to a pliers for levelling spacers. In particular, it is a pliers for pushing wedges of levelling spacers.

As is well known, levelling spacers comprising a one-way element in the form of a jumper with a through opening, and a levelling element, i.e. a wedge, are used to lay tiles all in the same plane.

The disposable element is placed between two tiles so that it also acts as a spacer, while the wedge is pushed into the through-opening.

The wedge, having a flat base, pushes the surface of the two adjacent tiles so that they are coplanar.

The pushing action of the wedge inside the through opening is achieved by a pliers that squeezes the disposable element on one side and the end of the wedge on the other.

Known pliers, used for the applications described above, present certain problems.

Firstly, they do not allow the wedge to move perfectly coplanar to the tile surface. This can only be adjusted by the operator.

Consequently, the result obtained, i.e. a perfect coplanarity of the tiles, can be affected by the lack of experience of the operator.

Another problem with known pliers lies in their poor adaptability to the different types of wedges used.

In fact, the wedges on the market, apart from the perfectly flat lower base, can have different shapes, particularly of the side end on which the pliers go to push.

As a result, one has to choose an appropriate pliers depending on the wedge used, with negative effects in terms of cost and material to be stored.

The aim of the invention is, therefore, to realise a pliers for levelling spacers that overcomes the problems of the known technique.

Another purpose of the invention is to provide a pliers for levelling spacers that can be used effectively and with optimal results, regardless of the skills and experience of the operator using it.

A further scope of the invention is to provide a spacer pliers that can be used for various types of wedges.

Yet another purpose of the invention is to provide a pliers for levelling spacers that can be easily adapted to the type of wedge to be pushed.

All the purposes and more are achieved, according to the invention, by a pliers for levelling spacers comprising a wedge and a disposable element, suitable for pushing a side face of the wedge so that it enters an opening of the disposable element so that the lower face of the wedge makes two adjacent tiles between which the disposable element is arranged coplanar.

### The Pliers Comprises

a handle capable of being grasped by an operator;
an elongated element to which is fixed a stop element capable of coupling to the disposable element;
a handle movably bound to the handle and capable of pushing the wedge.

The pliers are characterised by the fact that the handle includes at least one supporting body so that it can go against at least one of the two tiles.

Thanks to this feature, the operator is able to push the wedge through the pliers and at the same time find a foothold on the floor so that the pushing can be carried out comfortably and conveniently, thus avoiding unwanted movements of the pliers during use.

Advantageously, the handle may comprise a gripping body from which a first leg and a second leg descend, to which a first supporting body and a second supporting body are respectively attached to allow the pliers to rest on the tiles.

In this way, the pliers can have two points of support on the floor, so as to be even more stable.

In addition, the handle can include a spirit level, which is useful for checking the flatness of the tile or tiles on which the pliers rests.

Advantageously, the handle may be pivoted to the handle and include a gripping element and a push lever, which can be used to push the wedge.

In order to keep the pliers open when it is at rest, elastic means can be accommodated between the gripping element and the handle.

Advantageously, the pliers can comprise a pusher body that can be pushed by the push lever so that the wedge advances towards the disposable element.

In this way, the movement of the pusher body can be made to differ from that of the push lever. In fact, while the push lever can have a rotary movement, the pusher body can instead have a linear movement, like that which the wedge must perform.

Advantageously, the pusher body may comprise a front element with a stop face capable of engaging the side face of the wedge.

In particular, the striking face of the front element may have a conformation homologous to the side face of the wedge, so as to ensure an optimal coupling between the pusher body and the wedge and to obtain a perfect movement of the wedge.

In addition, the pusher body can be accommodated in a guide so as to have a determined movement.

Advantageously, the first supporting body can comprise a guide in which the pusher body can move.

Furthermore, the movement of the pusher body in the guide can be parallel to the tile on which the pliers rest, so that the wedge also moves according to the same movement.

Further features and details of the invention may be better understood from the following description, given by way of non-limiting example, as well as from the accompanying drawing plates, wherein

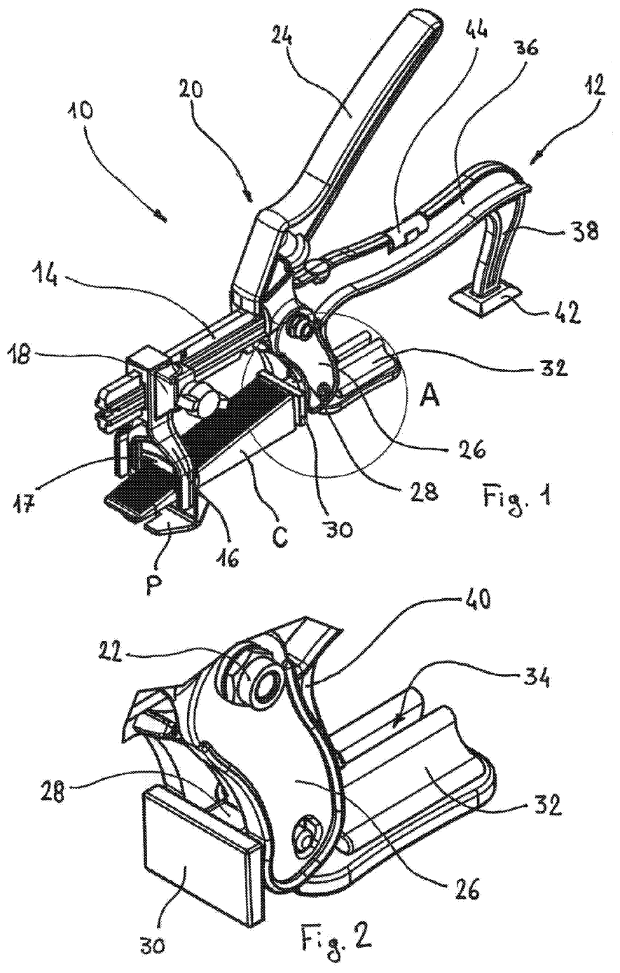

FIG. 1 is an axonometric view of a pliers for levelling spacers, according to the invention, in operation;

FIG. 2 is a view of a part of FIG. 1, indicated by A, without the wedge C present in FIG. 1;

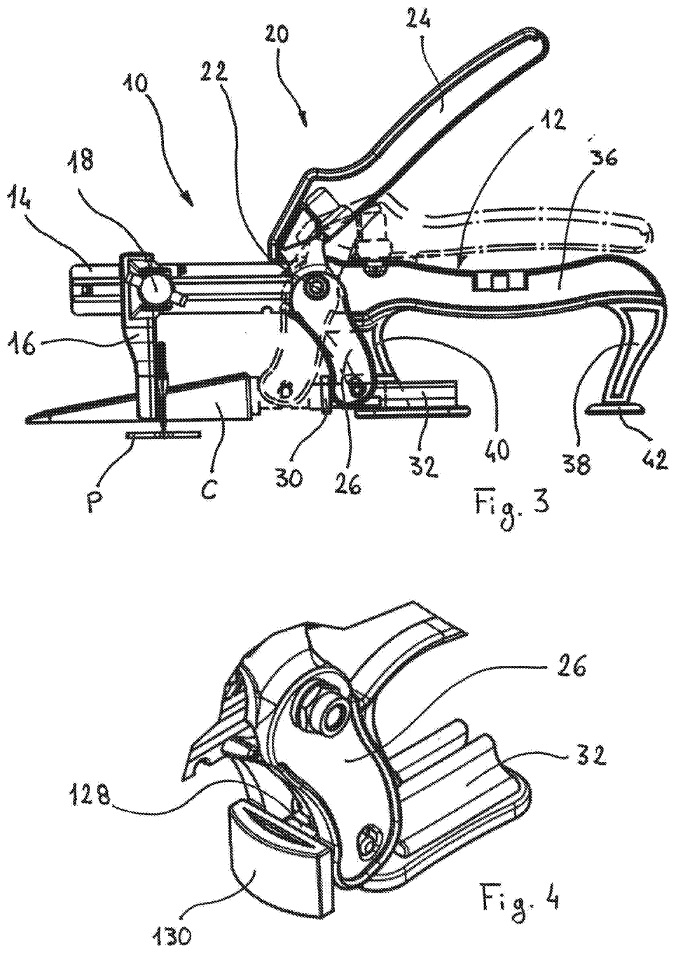

FIG. 3 is a side view of the pliers of FIG. 1;

FIG. 4 is a view of a part of a pliers according to a variant of the invention;

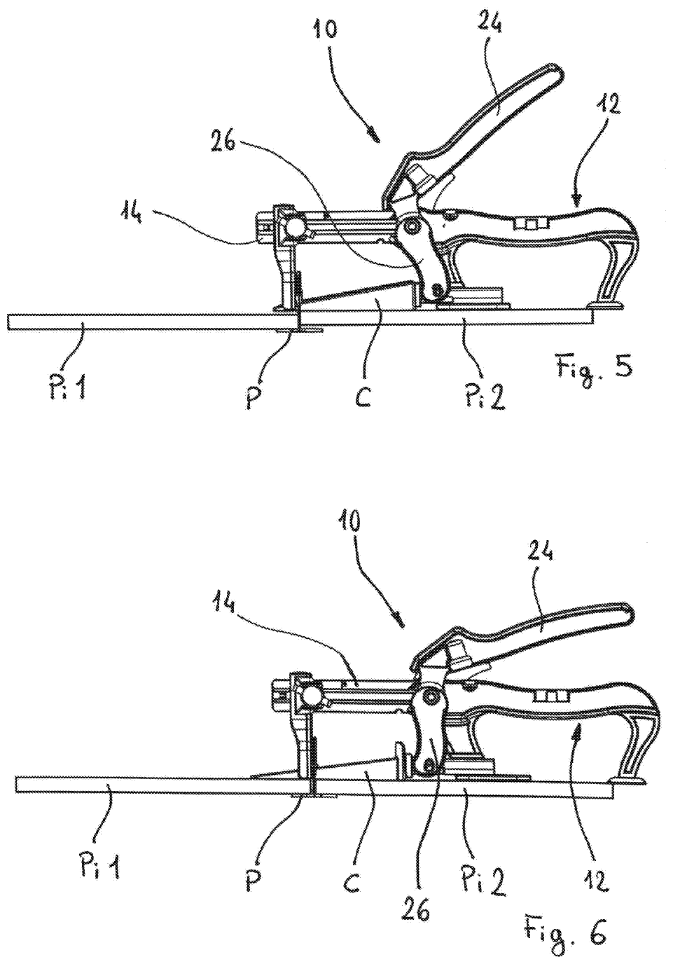

FIGS. 5 and 6 are side views of the pliers of FIG. 1 in the initial phase and in the final phase of its operation.

With reference to the appended Figures, in particular FIGS. 1 to 3, a pliers for levelling spacers 10 is referred to as 10, which is suitable for pushing a wedge C into the through opening obtained in the one-way jumper element P.

### The Pliers 10 for Levelling Spacers Comprises:

an inverted U-shaped handle 12;
an elongated track element 14, connected to the handle 12;
a movable stop element 16, capable of sliding on the extended track element 14 so as to be locked in the desired position by means of a locking device 18;
a handle 20, pivoted by means of a pin 22 at one end of the handle 12 and formed at the top by a gripping element 24 and at the bottom by a push lever 26;
a pusher body 28 provided with a front element 30;
a first support body 32 fixed to the handle 12 and in which a rectilinear seat 34 is formed into which the pusher body 28 can translate.

The handle 12 has an inverted U shape in that it comprises a gripping body 36 having a slightly arched shape from which a first leg 38 and a second leg 40 descend at the ends.

The first leg 38 can go to rest on the floor by means of a second support body 42, while the second leg 40 is fixed to the first support body 32, which is also intended to allow support on the floor.

Accordingly, the second support body 42 and the first support body 32 allow the handle 12 and, consequently, the entire pliers 10 to rest on the floor.

In order to verify the horizontal arrangement of the tiles on which the pliers 10 rests, a small spirit level 44 is arranged on the gripping body 36.

An arched seat 17 is formed in the movable stop element 16 suitable for accommodating or abutting on the disposable element or jumper, while the front element 30 of the pusher body 28 abuts on the side face of the wedge.

The movable stop element 16 can be arranged and fixed in position on the elongated track element 14 depending on the initial position of the wedge with respect to the disposable element.

A spring, not visible in the figures, is interposed between the gripping element 24 and the gripping body 36, so as to keep the gripping element 24 raised relative to the handle 12. Consequently, the pliers 10 remains open when it is at rest.

Once the movable stop element 16 and the front element 30 have been suitably positioned with respect to the disposable element and the wedge respectively, the operator can start to tighten the grip on the pliers 10, i.e. on the handle 20 and the grip 12, by bringing the gripping element 24 closer to the gripping body 36.

In this way, the push lever 26 pushes the front element 30 of the pusher body 28 guided in a straight direction into the seat formed in the first support body 32.

In turn, the front element 30 pushes the wedge inside the through opening obtained in the one-way jumper element, thereby arranging the two adjacent tiles in the same plane.

The particular configuration of the pliers 10 according to the invention allows the use of different shaped pusher bodies depending on the type of wedge to be pushed.

Indeed, as illustrated in FIG. 4, in the case where the wedge has, for example, a concave side face, a pusher body 128 with a convex front element 130 can be used.

In this way, it is sufficient to replace the pusher body and not the entire pliers, with positive consequences in terms of expense and material conservation.

In FIGS. 5 and 6, it is evident how the pliers 10 according to the invention allows the two tiles Pi1 and Pi2 to be made planar, and how the same pliers 10 can keep in contact with the tile Pi2, facilitating the work of the operator.

Further variations and embodiments other than those illustrated above are possible and are to be considered within the scope of protection defined by the appended claims.

For example, various pusher bodies can be used, with front elements of different shapes.

The handle may also have a different shape from the one described, maintaining however a ground support so as to verify the flatness of the tile on which the pliers rest.

The invention claimed is:

1. Pliers (10) for levelling spacers comprising a wedge and a disposable element, suitable for pushing a side face of the wedge so that it enters an opening of the disposable element so that the lower face of the wedge makes two adjacent tiles between which the disposable element is arranged, coplanar, said pliers (10) comprising:
a handgrip (12) capable of being grasped by an operator;
an elongated element (14) to which is fixed a stop element (16) capable of coupling with the disposable element;
a handle (20) movably attached to the handgrip (12) and suitable for pushing the wedge;
said gripper (10) being characterised by the fact that the handgrip (12) comprises at least one support body (32, 42) so as to support at least one of the two tiles.

2. Pliers (10) according to claim 1, wherein the handgrip (12) comprises a gripping body (36) from which descend a first leg (38) and a second leg (40) to which are respectively joined a first supporting body (32) and a second supporting body (42) so as to allow the support of the pliers (10) to the tiles.

3. Pliers (10) according claim 1, wherein the handgrip (12) comprises a spirit level (44).

4. Pliers (10) according to claim 1, wherein the handle (20) is pivoted to the handgrip (12) and comprises a gripping element (24) and a pushing lever (26) for pushing the wedge, elastic means being provided between the gripping element (24) and the handgrip (12) for keeping the pliers (10) open.

5. Pliers (10) according to claim 4, wherein a pushing body (28) is included for being pushed by the pushing lever (26) so as to advance the wedge towards the disposable element.

6. Pliers (10) according to claim 5, wherein the pusher body (28) comprises a front element (30) having a stop face suitable for engaging the side face of the wedge.

7. Pliers (10) according to claim 6, wherein the stop face of the front element (30) has a conformation homologous to the side face of the wedge.

8. Pliers (10) according to claim 5, wherein the pusher body (28) is received in a guide (32) so as to have a determined movement.

9. Pliers (10) according to claim 8, wherein the first support body (32) comprises a guide in which the pusher body (28) can translate.

10. Pliers (10) according to claim 8, wherein the movement of the pusher (28) in the guide is parallel to the tile on which the pliers (10) rests.
